(19) United States
(12) Patent Application Publication
(10) Pub. No.: US 2003/0195801 A1
(43) Pub. Date: Oct. 16, 2003

(54) System and method for providing advertisement data with conversation data to users

(76) Inventors: Tetsuo Takakura, Tokyo (JP); Masaomi Sato, Tokyo (JP)

Correspondence Address: LOWE HAUPTMAN GILMAN & BERNER, LLP, Suite 310, 1700 Diagonal Road, Alexandria, VA, 22314, US

(21) Appl. No.: 10/120,142

(22) Filed: Apr. 11, 2002

(51) Int. Cl. G06F 17/60

(52) U.S. Cl. 705/14

(57) ABSTRACT

A communication system according to this invention is constituted such that a server apparatus for processing mutual conversation data of a plurality of users and client apparatuses of the respective users are connected to each other. The server apparatus includes a chat processing section or a message processing section which can output advertisement data for performing advertisement to the users to the users through the information terminal apparatuses together with conversation data, and a communication processing control interface for transmitting the advertisement data and the conversation data to the client apparatuses.

### FIELD OF THE INVENTION

The present invention relates to a communication system, a communication information processing apparatus, an information terminal apparatus, a communication information processing method, and a storage medium for providing advertisement data with conversation data to users of chat or message transmission on Web.

### BACKGROUND OF THE INVENTION

With the development of the Internet technologies in recent years, communication systems in which a plurality of persons communicate with each other by using the internet technologies have been widely spread.

As such a general communication system using the internet, an electronic mail system which electrically distributes character data, image data, and the like through a server device, a chat system in which users can conversed with each other in a virtual conversation room (chat room), or a message transmission system in which a user can actively transmit a message to another user is known.

In these systems, the chat system or the message transmission system is excellent because a sentence input through a client device is immediately reflected on a Web page of the opposite party, and is excellent as a virtual conversation system.

Since these systems have the above advantages, users of the chat system and the message transmission system sharply increase in number, and the number of Web sites which present chat environments and message transmission environments increase day by day.

However, although such a conventional chat system or a message transmission system presents the excellent conversation environment, the conversation environment is still only a conversation environment. More specifically, the chat system and the message transmission system are used by a large number of persons, and have the fact that the users very strongly pay attentions to the screens of the chat system and the message transmission system. However, any attempts are not made to use the characteristics in objects other than the conversation system.

In earning sources of recent Web sites, advertisement and public relations occupy large parts. It is important that spaces in which advertisement and public relations can be performed are secured. For this reason, nowadays, a large number of belt-like advertisements called banner advertisements are displayed on various Web pages. However, spaces on Web pages in which such advertisements can be inserted are gradually limited, and spaces which are out of the Web pages and which can achieve effective advertisement and public relations are eagerly desired.

### SUMMARY OF THE INVENTION

The present invention has been achieved in order to solve the above problems. It is an object of the present invention to provide a communication system, a communication information processing apparatus, an information terminal apparatus, a communication information processing method, and a storage medium which can display advertisements in chat or message transmission and which can create novel advertisement spaces.

In order to achieve the above object, according to a first aspect of the present invention, there is provided a communication system comprising, a communication information processing apparatus for processing mutual conversation data of a plurality of users, and an information terminal apparatus associated with each of the respective users, and which is connected to the communication information processing apparatus through a computerized network, wherein, said communication information processing apparatus includes, a conversation process arrangement for outputting both advertisement data which is representative of advertisement to the users and the conversation data, and a first communication arrangement for transmitting the advertisement data and the conversation data to said information terminal apparatus, and wherein, said information terminal apparatus includes, a second communication arrangement for receiving the advertisement data and the conversation data transmitted from said communication information processing apparatus, and an output arrangement for simultaneously outputting the conversation data and the advertisement data.

According to the first aspect, advertisement data for performing advertisement for users can be output to the users together with conversation data, and the advertisement data and the conversation data are transmitted to the information terminal apparatus. In the information terminal apparatus, the conversation data and the advertisement data are simultaneously output to make it possible to perform advertisement to users. In this manner, a new advertisement space can be created in a conversation environment, for example, a region which has not attracted attention as an advertisement space. In this case, since the advertisement data is displayed together with the conversation data which attracts a great deal of attention of the users, advertisement and public relations effects are extremely great.

A second aspect of the present invention provides the communication system according to the first aspect, wherein the conversation data is at least one of the following, chat information for displaying conversation contents, which is transmitted from the plurality of information terminal apparatuses, on the information terminal apparatuses, or message information for displaying the conversation contents, which is transmitted from the information terminal apparatuses, on other information terminal apparatuses.

This shows the contents of the conversation data more specifically. According to the second aspect, advertisements are displayed together with the chat information for performing chat and message information for performing message transmission. Therefore, in case of chat, an advertisement is watched by a user while waiting the next comment of the opposite party, or the advertisement is talked about in the chat, so that great advertisement and public relations effects can be expected. In case of message transmission, an advertisement can be actively transmitted together with a message, and great advertisement and public relations effects can be expected.

The present invention relates a communication information processing apparatus for processing mutual conversation data of a plurality of users, and which is connected to an information terminal apparatus associated with each of users through a computerized network, comprising, a conversation process arrangement for outputting both advertisement data which is representative of advertisement to the users and the conversation data, and a communication arrangement for transmitting the advertisement data and the conversation data to said information terminal apparatus.

According to the third aspect, advertisement data for performing advertisement for users can be output to the users together with conversation data, and the advertisement data and the conversation data are transmitted to the information terminal apparatuses. Therefore, in the information terminal apparatuses, advertisement data is output to users together with conversation data, and advertisement data can be performed for the users. In this manner, a new advertisement space can be created in a conversation environment, i.e., a region which has not attracted attention as an advertisement space. In this case, since the advertisement data is displayed together with the conversation data which attracts a great deal of attention of the users, advertisement and public relations effects are extremely great.

A fourth aspect of the present invention provides the communication information processing apparatus according to the third aspect, wherein, the conversation data is at least one of he following, chat information for displaying conversation contents, which is transmitted from the plurality of information terminal apparatuses, on the information terminal apparatuses, or message information for displaying the conversation contents, which is transmitted from the information terminal apparatuses, on other information terminal apparatuses.

This shows the contents of the conversation data more specifically. According to the fourth aspect, advertisements are displayed together with the chat information for performing chat and message information for performing message transmission. Therefore, in case of chat, an advertisement is watched by a user while waiting the next comment of the opposite party, or the advertisement is talked about in the chat, so that great advertisement and public relations effects can be expected. In case of message transmission, an advertisement can be actively transmitted together with a message, and great advertisement and public relations effects can be expected.

A fifth aspect of the present invention provides the communication information processing apparatus according to the third or fourth aspects, comprising an advertisement selection process arrangement for selecting advertisement data from plurality of advertisement data. According to the fifth aspect, advertisement data to be presented to users is selected from the plurality of advertisement data, and is presented to the users. Therefore, when this selection is appropriately performed, an advertisement which is appropriate to the users can be automatically selected and presented to the users.

A sixth aspect of the present invention provides the communication information processing apparatus according to the fifth aspect, comprising a transmission history data base for storing information for specifying a Web page transmitted to the information terminal apparatus, wherein, the advertisement selection process arrangement selects the advertisement data on the basis of the information stored in the transmission history database.

This shows one form of advertisement selection references more specifically. According to the sixth aspect, a transmission history of Web pages to users is automatically stored, and an advertisement is selected on the basis of the transmission history. For this reason, an advertisement which is browsed by the users and which is related to a manufacture, a product, and the like and an advertisement related to a manufacture, a product, and the like which are completely different from the manufacture, the product, and the like of the advertisement which is browsed by the users can be presented, i.e., an advertisement based on browsing contents can be presented, so that advertisement and public relations effects can be more improved.

A seventh aspect of the present invention provides the communication information processing apparatus according to the fifth or sixth aspect, wherein the advertisement selection process arrangement selects the advertisement data on the basis of the contents of the conversation data.

This shows another form of advertisement selection references more specifically. According to the seventh aspect, since advertisement data is selected on the basis of the contents of conversation data, an advertisement about which users converse with each other and which are related to a manufacture, a product, and the like and an advertisement which is related to a manufacture, a product, and the like which are completely different from the manufacture, the product, and the like of the advertisement about which the users converse with each other can be presented, i.e., an advertisement based on the conversation contents can be presented, so that advertisement and public relations effects can be more improved.

An eighth aspect of the present invention provides the communication information processing apparatus according to any one of the fifth to seventh aspects, comprising a user attribute data base for storing information related to attributes of said users, wherein, the advertisement selection process arrangement selects the advertisement data on the basis of the information stored in the user attribute database.

This shows another form of advertisement selection references more specifically. According to the eighth aspect, the information related to the attributes of the users, and an advertisement is selected on the basis of the information. For this reason, advertisement which is related to a manufacture, a product, or and the like which correspond to the sexes, the hobbies, and the like of the users and advertisement which is related to a manufacture, a product, and the like which are completely different from the manufacture, the product, and the like which correspond to the sexes, the hobbies, and the like of the users can be presented, i.e., an advertisement based on the attributes of the users can be presented, so that advertisement and public relations effects can be more improved.

A ninth aspect of the present invention provides the communication information processing apparatus according to any one of the third to eighth aspects, wherein the conversation process arrangement switches the advertisement data under predetermined conditions.

According to the ninth aspect, since the advertisement data are automatically switched, different advertisements can be automatically presented to users, and advertisement efficiency can be improved.

A tenth aspect of the present invention provides the communication information processing apparatus according to the ninth aspect, wherein, when the conversation data is chat information, and when a transmit time of the advertisement data for users who participate in the same chat room exceeds a predetermined time, the conversation process arrangement switches the advertisement data.

This shows one form of advertisement switching references more specifically. According to the tenth aspect, since the advertisement data are switched when the present time of the advertisement data for the users who participate in the chat room is not shorter than the predetermined time, the next advertisement can be presented to the users while advertisements are sufficiently shown to the users, and the advertisements can be efficiently updated.

A eleventh aspect of the present invention provides the communication information processing apparatus according to any one of the third to tenth aspects, wherein the conversation process arrangement transmits selection information, which is for selecting advertisement data from plurality of advertisement data, to said information terminal apparatus, and allow the advertisement data, which is selected by using the selection information, to be output to said information terminal apparatus.

According to the eleventh aspect, the selection information for selecting advertisement data to be presented from the plurality of advertisement data is transmitted to the information terminal apparatuses, and the advertisement data selected by using the selection information can be output through the information terminal apparatus together with the conversation data. More specifically, a user can select advertisement data by using the selection information, and the advertisement data selected as described above is presented to the user. Therefore, in chat or message transmission, a user can perform arbitrary selection of an advertisement corresponding to the opposite party and the like, and advertisement and public relations effects can be more improved.

A twelfth aspect of the present invention provides the communication information processing apparatus according to any one of the third to eleventh aspects, comprising a profit information data base for storing profit information for specifying the contents of a profit offered to users, and a profit process arrangement for, when a predetermined operation by the user is performed through said information terminal apparatus for advertisement data presented to the user, specifying the contents of a profit offered to at least either the user who performed the predetermined operation or other user who selects the advertisement data to be presented to the user, and storing the contents in the profit information data base.

According to the twelfth aspect, when the predetermined operation is performed to the advertisement data, the contents of a profit offered to at least one of a user who performs this operation and a user who selects that the advertisement data is presented to the user are stored. More specifically, for example, when the advertisement data is selected to browse the detailed contents of the advertisement data, a predetermined profit is given to at least one of these users. Therefore, an incentive related to an improvement in advertisement effect can be given to users who watch the advertisement and users who transmit advertisement, and advertisement and public relations effects can be more improved.

The present invention relates to an information terminal apparatus. According to a thirteenth aspect of the present invention, there is provide an information terminal apparatus which is connected to a communication information processing apparatus for processing mutual conversation data of a plurality of users through a computerized network, comprising, a communication arrangement for receiving the advertisement data and the conversation data transmitted from said communication information processing apparatus, and an output arrangement for simultaneously outputting the conversation data and the advertisement data.

According to the thirteenth, the conversation data and the advertisement data transmitted from the communication information processing apparatus can be simultaneously output through the output interface. Therefore, the advertisement data is output to users together with the conversation data, so that advertisement for the users can be performed. Since the conversation data especially attracts a great deal of attention, advertisement and public relations effects are extremely great.

A fourteenth aspect of the present invention provides the information terminal apparatus according to the thirteenth aspect, further comprising an input arrangement for being used to input a data, wherein, the communication arrangement receives selection information, which is transmitted from said communication information processing apparatus, for selecting advertisement data from plurality of advertisement data, the output arrangement outputs the selection information received by the communication arrangement, the input arrangement is used to input the selection information, to specify the advertisement data based on the selection information, and the communication arrangement transmits information related to the advertisement data, which is specified based on the selection information inputted by using the input interface, to said communication information processing apparatus.

According to the fourteenth aspect, the selection information is output through the output interface, and the advertisement data is specified by using the selection information through the input interface. Therefore, a user can easily select advertisement data.

The present invention relates to a communication information processing method. According to a fifteenth aspect of the present invention, there is provided a communication information processing method in a system including, a communication information processing apparatus for processing mutual conversation data of a plurality of users, and an information terminal apparatus associated with each of the respective users, which is connected to the communication information processing apparatus through a computerized network, comprising the steps of, (a) outputting both advertisement data which is representative of advertisement for users and the conversation data, in said communication information processing apparatus, and (b) transmitting the advertisement data and the conversation data from the communication information processing apparatus to the information terminal apparatus.

According to the fifteenth aspect, the advertisement data for performing advertisement for the users can be output to the users together with the conversation data, and the advertisement data and the conversation data are transmitted to the information terminal apparatuses. Therefore, in the information terminal apparatuses, the advertisement data are used by the users together with the conversation data, and advertisement can be performed for the users. In this manner, a new advertisement space can be created in a conversation environment, i.e., a region which has not attracted attention as an advertisement space. In this case, since the advertisement data is displayed together with the conversation data which attracts a great deal of attention of the users, advertisement and public relations effects are extremely great.

A sixteenth aspect of the present invention provides the communication information processing method according to the fifteenth aspect, wherein the conversation data is at least one of following, chat information for displaying conversation contents, which is transmitted from the plurality of information terminal apparatuses, on the information terminal apparatuses, or message information for displaying the conversation contents, which is transmitted from the information terminal apparatuses, on other information terminal apparatuses.

This shows the contents of the conversation data more specifically. According to the sixteenth aspect, advertisements are displayed together with the chat information for performing chat and message information for performing message transmission. Therefore, in case of chat, an advertisement is watched by a user while waiting the next comment of the opposite party, or the advertisement is talked about in the chat, so that great advertisement and public relations effects can be expected. In case of message transmission, an advertisement can be actively transmitted together with a message, and great advertisement and public relations effects can be expected.

A seventeenth aspect of the present invention provides the communication information processing method according to the fifteenth or sixteenth aspect, further comprising the steps of, (c) selecting advertisement data from plurality of advertisement data, before the outputting step (a).

According to the seventeenth, the advertisement data to be presented to users is selected from the plurality of advertisement data and presented to the users. Therefore, when this selection is appropriately performed, an advertisement which is appropriate to the users can be automatically selected and presented to the users.

An eighteenth aspect of the present invention provides the communication information processing method according to the seventeenth aspect, further comprising the steps of, (d) storing information for specifying a Web page transmitted to the information terminal apparatus, in said communication information processing apparatus, and wherein, on the selecting step (c), the advertisement data is selected on the basis of the information stored in the storing step (d).

This shows one form of advertisement selection references more specifically. According to the eighteenth aspect, a transmission history of Web pages to users is automatically stored, and an advertisement is selected on the basis of the transmission history. For this reason, an advertisement which is browsed by the users and which is related to a manufacture, a product, and the like and an advertisement related to a manufacture, a product, and the like which are completely different from the manufacture, the product, and the like of the advertisement which is browsed by the users can be presented, i.e., an advertisement based on browsing contents can be presented, so that advertisement and public relations effects can be more improved.

A nineteenth aspect of the present invention provides the communication information processing method according to the seventeenth or eighteenth aspect, wherein, on the selecting step (c), the advertisement data is selected on the basis of the contents of the conversation data.

This shows another form of advertisement selection references more specifically. According to the nineteenth aspect, since advertisement data is selected on the basis of the contents of conversation data, an advertisement about which users converse with each other and which are related to a manufacture, a product, and the like and an advertisement which is related to a manufacture, a product, and the like which are completely different from the manufacture, the product, and the like of the advertisement about which the users converse with each other can be presented, i.e., an advertisement based on the conversation contents can be presented, so that advertisement and public relations effects can be more improved.

A twentieth aspect of the present invention provides the communication information processing method according to any one of the seventeenth to nineteenth aspects, further comprising, (e) storing information related to attributes of said users, and wherein, on the selecting step (c), the advertisement data is selected on the basis of the information stored in the storing step (e).

This shows another form of advertisement selection references more specifically. According to the twentieth aspect, the information related to the attributes of the users, and an advertisement is selected on the basis of the information. For this reason, advertisement which is related to a manufacture, a product, or and the like which correspond to the sexes, the hobbies, and the like of the users and advertisement which is related to a manufacture, a product, and the like which are completely different from the manufacture, the product, and the like which correspond to the sexes, the hobbies, and the like of the users can be presented, i.e., an advertisement based on the attributes of the users can be presented, so that advertisement and public relations effects can be more improved.

A twenty-first aspect of the present invention provides the communication information processing method according to any one of the fifteenth to twentieth aspects, wherein, on the outputting step (a), the advertisement data is switched under predetermined conditions.

According to the twenty-first aspect, since the advertisement data are automatically switched, different advertisements can be automatically presented to users, and advertisement efficiency can be improved.

A twenty-second aspect of the present invention provides the communication information processing apparatus according to the twenty-first aspect, wherein, on the outputting step (a), when the conversation data is chat information, and when a transmit time of the advertisement data for users who participate in the same chat room exceeds a predetermined time, the advertisement data is switched.

This shows one form of advertisement switching references more specifically. According to the twenty-second aspect, since the advertisement data are switched when the present time of the advertisement data for the users who participate in the chat room is not shorter than the predetermined time, the next advertisement can be presented to the users while advertisements are sufficiently shown to the users, and the advertisements can be efficiently updated.

A twenty-third aspect of the present invention provides the communication information processing method according to any one of the fifteenth to twenty-second aspects, wherein, on the outputting step (a), the selection information is transmitted for selecting advertisement data from plurality of advertisement data, from said communication information processing apparatus to said information terminal apparatus, and the advertisement data, which is selected by using the selection information, is allowed to be transmitted to said information terminal apparatus.

According to the twenty-third aspect, the selection information for selecting advertisement data to be presented from the plurality of advertisement data is transmitted to the information terminal apparatuses, and the advertisement data selected by using the selection information can be output through the information terminal apparatus together with the conversation data. More specifically, a user can select advertisement data by using the selection information, and the advertisement data selected as described above is presented to the user. Therefore, in chat or message transmission, a user can perform arbitrary selection of an advertisement corresponding to the opposite party and the like, and advertisement and public relations effects can be more improved.

A twenty-fourth aspect of the present invention provides the communication information processing method according to any one of the fifteenth to twenty-third aspects, further comprising, (f) storing profit information for specifying the contents of a profit offered to the users; and (g) when a predetermined operation by the user is performed through said information terminal apparatus for advertisement data presented to the user, specifying the contents of a profit offered to at least either the user who performed the predetermined operation or other user who selects the advertisement data to be presented to the user, and storing the contents in said communication information processing apparatus.

According to the twenty-fourth aspect, when a predetermined operation is performed to the advertisement data, the contents of a profit offered to at least one of a user who performs this operation and a user who selects that the advertisement data is presented to the user are stored. More specifically, for example, when the advertisement data is selected to browse the detailed contents of the advertisement data, a predetermined profit is given to at least one of these users. Therefore, an incentive related to an improvement in advertisement effect can be given to users who watch the advertisement and users who transmit advertisement, and advertisement and public relations effects can be more improved.

The present invention relates to a storage medium. According to a twenty-fifth aspect of the present invention, there is provided a computer-readable recording medium, wherein a computer program for a computer to execute a communication information processing method according to the present invention is recorded.

According to the twenty-fifth aspect, the program recorded on the storage medium is loaded and executed by the computer, so that the communication information processing method according to any one of the fifteenth to twenty-fourth aspects can be realized by using the computer, and the same effects as those obtained in these methods can be obtained.

Other objects and features of this invention will become understood from the following description with reference to the accompanying drawings.

### BRIEF DESCRIPTION OF DRAWINGS

FIG. 1 is a block diagram showing the entire configuration of a communication system according to an embodiment of the present invention;

FIG. 2 is a block diagram showing the configuration of a server apparatus;

FIG. 3 is a block diagram showing the configuration of a client apparatus;

FIG. 4 is a diagram showing a configuration of information stored in a member DB;

FIG. 5 is a diagram showing a configuration of information stored in a transmission history DB;

FIG. 6 is a diagram showing a configuration of information stored in a chat DB;

FIG. 7 is a diagram showing a configuration of information stored in an advertisement DB;

FIG. 8 is a flow chart of a chat process;

FIG. 9 is a flow chart of an advertisement updating process;

FIG. 10 is a flow chart of a message transmission process;

FIG. 11 is a flow chart of a message transmission process;

FIG. 12 is a diagram showing a display of a Web browser;

FIG. 13 is a diagram showing a display of a chat room;

FIG. 14 is a diagram showing a display of a message forming screen; and

FIG. 15 is a diagram showing a display of a message transmission screen.

### DETAILED DESCRIPTIONS

Embodiments of a communication system, a communication information processing apparatus, an information terminal apparatus, a communication information processing method and a storage medium according to the present invention will be described below with reference to the accompanying drawings. The present invention is not limited to the embodiments.

(Outline of the Whole)

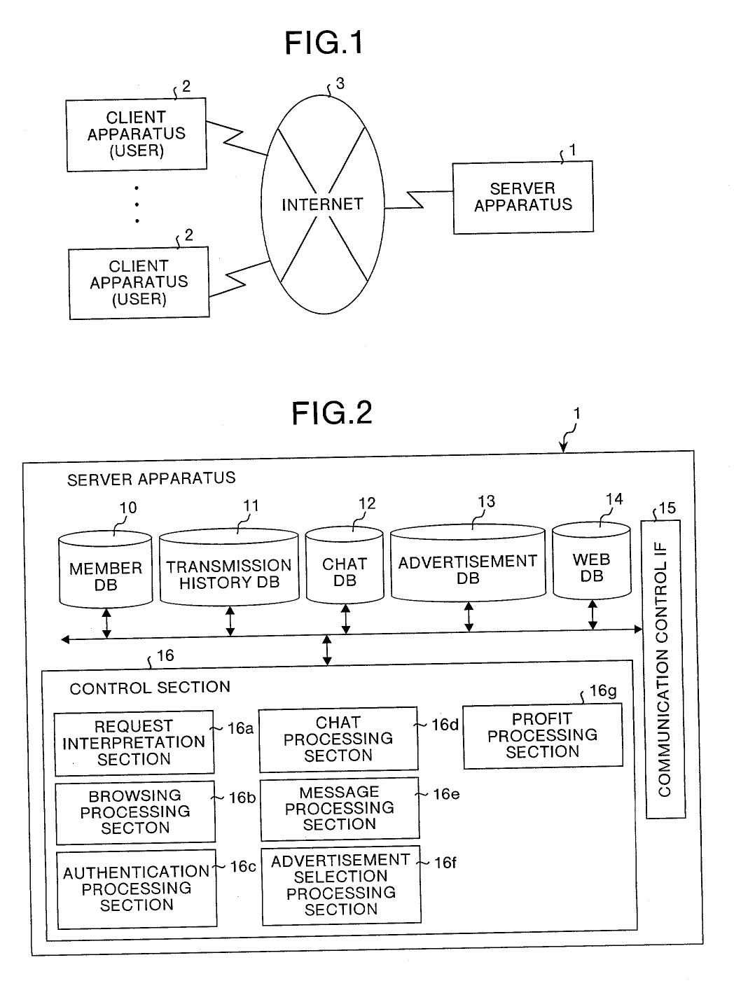

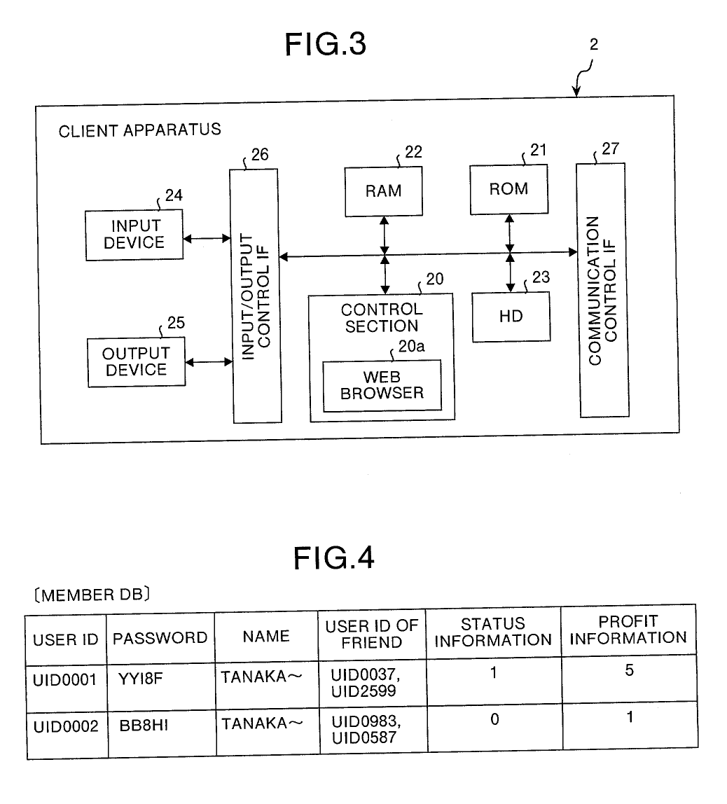

FIG. 1 is a block diagram showing the entire configuration of this system. This system is constituted by connecting, as shown in FIG. 1, a server apparatus 1 serving as a communication information processing apparatus and a plurality of client apparatuses 2 serving as information terminal apparatuses of users to each other such that the server apparatus 1 and the plurality of client apparatuses 2 communicate with each other through internet 3. The outline of the system will be described below. Thereafter, the configuration, processes, and the like of this system will be described below.

The server apparatus 1 is constituted as an ISP server held by an ISP (Internet Service Provider). A user who is registered as a member in the system logs on the server apparatus 1 through the client apparatus 2, and can access an arbitrary Web server (not shown) through the server apparatus 1. The data (Web data) of an arbitrary Web page stored in the Web server is downloaded through the server apparatus 1, so that the Web page can be browsed.

In the system, a plurality of Web data constituting a plurality of chat rooms are stored in the server apparatus 1. A user who is registered as a member of the system accesses the server apparatus 1 through the client apparatus 2, participates in chat, and can perform message transmission.

Of these operations, the chat performed in this embodiment is opened in every Web page browsed by a user. More specifically, when the user browses a Web page, the user requests the manager of the system to participate in chat, so that the user can participates in a chat room in which another user who browses the same Web page participates.

Message transmission performed in this embodiment can be actively performed by users who log in the system. More specifically, a user designates another user who logs in the system, and can transmit an arbitrary message. This message is automatically displayed on the client apparatuses 2 of the other user.

The chat and the message transmission themselves have been known, and can be performed in the same manner as that of a conventional technique.

A basic characteristic feature for distinguishing the system from a conventional system is that an advertisement is displayed on a screen for chat or message transmission.

In chat, an advertisement is automatically displayed in a chat room. Therefore, a plurality of users who participate in the same chat room perform chat while watching the same advertisement.

As a method of determining advertisement contents in the chat, various methods can be considered. However, since a chat room is opened in every Web page in this embodiment as described above, as the advertisement, an advertisement related to the Web page is automatically selected.

In the message transmission, when a message is transmitted to a user, and an advertisement is automatically displayed together with the message. Therefore, this advertisement is watched by only a user who receives the message but a user who transmits the message.

As a method of determining advertisement contents in the message transmission, various methods can be considered. In this embodiment, a user who transmits a message selects an arbitrary advertisement matched to a user who receives the message. For this reason, selection information for selecting an advertisement is transmitted to the user who transmits the message. The user selects an advertisement with reference to the selection information.

(System Configuration-Server Apparatus 1)

The configuration of this system for structuring such a communication environment will be described below.

The configuration of the server apparatus 1 will be described below. FIG. 2 is a block diagram showing the configuration of the server apparatus 1. As shown in FIG. 2, the server apparatus 1 is roughly constituted by a member DB (DB=database) 10, a transmission history DB 11, a chat DB 12, an advertisement DB 13, a Web DB 14, a communication control IF (IF=interface) 15, and a control section 16. These parts are connected to each other such that the parts can communicate with each other through an arbitrary communication path. In addition, the server apparatus 1 is connected to the Internet 3 such that the server apparatus 1 can communicate with the Internet 3 through a communication apparatus (not shown) such as router and a leased line. Although access to each DB is actually performed through a DBMS (Database Management System), the DBMS will be omitted.

Of the constituent elements of the server apparatus 1, the member DB 10 is a user information storage unit which stores information related to users registered as members of this system and, at the same time, a profit information storage unit which stores profit information for specifying the contents of profits offered to the respective users.

Concrete information stored in the member DB 10 is constituted such that, for example, as shown in FIG. 4, a user ID for uniquely identifying each user, a password for performing authentication of each user, the name of each user, the user IDs of other users registered as friends by each user, status information (in this case, a flag in a log-in state is set to be “1”, and a flag in a log-out state is set to be “0”) representing a log-in status of each user, and profit information for specifying a profit offered to each user are associated with each other.

In this case, the profit information is information for specifying the contents and the quantity of a profit given by the system to a user who perform predetermined transmission and reception of advertisement data. This profit can include all profits, which can be profits for users, such as cash, exchange tickets, premiums, points which can be used to purchase arbitrary products or services, discounts of various fees, and the like. However, in this embodiment, it is assumed that the profit is virtual money (to be referred to as VM hereinafter) which can be used in a predetermined electrical commercial transaction site on internet 3, and it is assumed that the profit information is cumulative points of the VM.

An investor (person or company offering capital) of the profit is arbitrary. For example, the capital a sponsor may offer a capital, and the opener of the system may offer a capital to promote the use of the system.

The transmission history DB 11 is a transmission history storage unit which stores information for specifying a Web page transmitted to the client apparatus 2 of the user.

Concrete information stored in the transmission history DB 11 is constituted such that, for example, as shown in FIG. 5, the user ID of each user and the URL of a Web page which is finally transmitted from the server apparatus 1 to each user are associated with each other.

As information for specifying a Web page, arbitrary information such as an IP address can be used. In addition, a Web page including its class is not necessarily specified. For example, information for specifying the higher class of a homepage level may be stored.

The chat DB 12 is a chat information storage unit which stores information related to a chat room opened at this time.

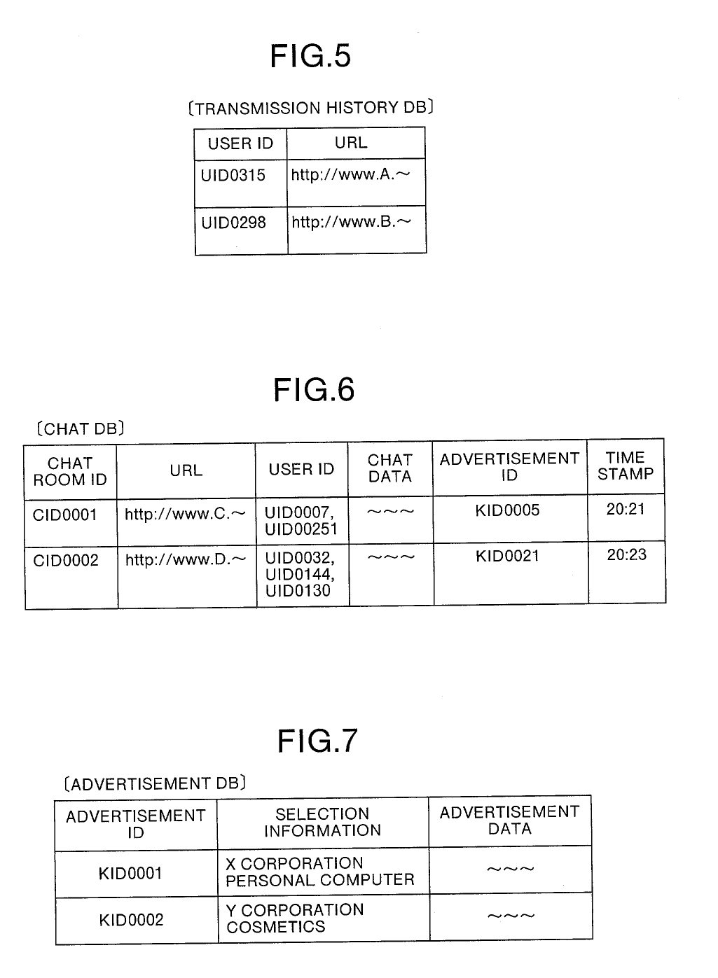

Concrete information stored in the chat DB 12 is constituted such that, for example, as shown in FIG. 6, a chat room ID for uniquely identifying each chat room, the URL of a Web page corresponding to each chat room, the user ID of a user who participates in each chat room, chat data constituting output information of each chat room (or address information, a file name, or the like for specifying chat data. The contents are omitted in FIG. 6), the advertisement ID (to be referred later) of an advertisement displayed in each chat room, and a time stamp indicating a participation time of a user who finally participates in each chat room are associated with each other.

The advertisement DB 13 is an advertisement data storage unit which stores advertisement data or the like to be displayed in chat or message transmission.

Concrete information stored in the advertisement DB 13 is constituted such that, for example, as shown in FIG. 7, an advertisement ID for uniquely identifying each advertisement data, selection information for selecting advertisement data to be presented from plurality of advertisement data, and advertisement data (or address information, a file name, or the like for specifying advertisement data) are associated with each other.

As the selection information, arbitrary information which can serve as a reference when each user selects an advertisement can be used. In this case, text data briefly expressing the contents of each advertisement data is stored. In addition, as the selection information, reduced image data (thumbnail) is used when advertisement data is image data, or text data merely representing the name of a sponsor or text data representing the name of a product or the like which is an object to be advertised can be used. The contents of text advertisement data can be dynamically summarized as needed. In this case, the selection information may not be stored.

The advertisement data may be constituted by appropriately combining text data, still image data, moving image data, and audio data to each other.

In the Web DB 14, various Web data to be transmitted to the client apparatuses 2 are stored. As the Web data, data or the like for displaying a message forming screen (to be described later) is known. These data are formed as text files described by HTML or XML. In addition, in the Web DB 14, if necessary, voice to be transmitted to the client apparatus 2 is stored by an audio file of WABE form or AIFF form, and a still image or a moving image can be stored by an image file of JPEG form or MPEG2 form.

In FIG. 1, the communication control IF 15 performs communication control between the server apparatus 1 and the internet 3 (communication apparatus such as a router), and is a communication unit which transmits advertisement data and conversation data (chat data or message data) to the client apparatus 2.

In FIG. 1, the control section 16 is functionally conceptually constituted by a request interpretation section 16a, a browsing processing section 16b, an authentication processing section 16c, a chat processing section 16d, a message processing section 16e, an advertisement selection processing section 16f, and a profit processing section 16g.

Of these units, the request interpretation section 16a is a request interpretation unit which interprets request contents from the client apparatus 2 and which gives processes to the respective units of the control section 16. The browsing processing section 16b is a browsing processing unit which receives browsing requests of various screens from the client apparatus 2 to generation and transmission of Web data of these screens. The authentication processing section 16c is an authentication processing unit which receives an authentication request from the client apparatus 2 to perform authentication determination.

The chat processing section 16d is a chat processing unit which performs processes related to an operation of chat such as generation of Web data of a chat page or management of users who participate in the chat, and is a conversation processing unit which can output advertisement data for performing advertisement for user to the users through the client apparatuses 2 together with conversation data (chat data) for displaying conversation contents transmitted from the plurality of client apparatuses 2 on the respective client apparatuses 2. The chat processing section 16d automatically switches advertisement data under predetermined conditions.

The message processing section 16e is a message transmission unit which performs generation of various screens for message transmission and transmission control therefor, and is a conversation processing unit which can output advertisement data for performing advertisement for users to the users through the client apparatuses 2 together with conversation data (message information) for displaying conversation contents transmitted from the client apparatuses 2 on the respective client apparatuses 2.

In this case, as the concrete contents in which the advertisement data can be output together with the conversation data, various forms may be employed. In this embodiment, as will be described later, advertisement data may be added to chat data including the conversation data or Web data of a message transmission screen. In addition, only tag information for simultaneously outputting advertisement data is included in the chat data and the Web data of the message transmission screen, and only the advertisement data may be transmitted. Furthermore, transmission timing and a transmission form of the advertisement data are arbitrarily determined. For example, when the client apparatus 2 logs in the system, an empty time in which no communication data exists is detected, one advertisement data or plurality of advertisement data using this time may be transmitted in advance and stored in the client apparatus 2.

The advertisement selection processing section 16f is an advertisement selection processing unit which selects advertisement data presented to users from plurality of advertisement data.

The profit processing section 16g is a profit processing unit which, when a predetermined operation by a user is performed to advertisement data presented to the user through the client apparatus 2, specifies the contents of a profit offered to at least one of the user and a user who selects that the advertisement is presented to the user, and which stores the contents in the member DB 10. The predetermined operation is that the advertisement data (advertisement display region MD-4 (to be described later)) to browse other data hyperlinked to the advertisement data.

The details of processes performed by these units will be described later.

The configuration of the server apparatus 1 has been described up to now. However, the illustrated constituent elements are functionally conceptual, and are not necessarily physically constituted as illustrated in the drawings.

For example, process functions held by the servers of the server apparatus 1, in particular, all or arbitrary some of process functions performed by the control section 16 can be realized by a CPU (Central Processing Unit) and a program which is interpreted and executed by the CPU, or can be realized as hardware obtained by wired logic circuits. The program is stored in the storage medium (not shown) and mechanically read by the server apparatus 1 as needed.

In addition, the concrete forms of dispersion and integration of the server apparatus 1 are not limited to the illustrated forms, and all or some of these elements may be constituted in arbitrary units depending on various loads or the like such that the elements are functionally or physically dispersed or integrated. For example, the Web DB 14 may be independently constituted as the Web server apparatus 1, or the member DB 10 and the transmission history DB 11 maybe integrally constituted as one DB. As the actual configuration function of the server apparatus 1, the functions of a fire wall server and a DNS (Domain Name System) server can be added. However, since known configurations can be applied to these functions, a description thereof will be omitted.

(System Configuration-Client Apparatus 2 of User)

The configuration of the client apparatus 2 of a user will be described below. As shown in FIG. 1, the client apparatus 2 is roughly constituted by a control section 20, a ROM 21, a RAM 22, an HD 23, an input device 24, an output device 25, an input/output control IF 26, and a communication control IF 27. The units are connected to each other such that the units can communicate with each other through a bus.

The client apparatus 2 can be realized by, for example, a personal computer, a workstation, a home video game, an internet TV, a PDA (Personal Digital Assistant), or a mobile communication terminal, e.g., a portable telephone or a PHS (Personal Handy Phone System).

The control section 20 of the client apparatus 2 is constituted by a Web browser 20a. This Web browser 20a basically interprets Web data to perform display control (browsing process) for displaying the Web data on a monitor 25 (to be described later).

This control section 20 can be realized by a CPU or a program which is entirely or partially interpreted and executed by the CPU. More specifically, a computer program which gives an instruction to the CPU in cooperation with an OS (Operating System) is stored in the ROM 21 or the HD 23. This computer program is executed by loading the computer program on the RAM 22, and constitutes the control section 20 in cooperation with the CPU.

However, this computer program may be stored in an application program server connected to the client apparatus 2 through the arbitrary internet 3, and all or part of the computer program can also be downloaded as needed. All or arbitrary some of the control sections 20 can also be realized as hardware obtained by wired logic circuits or the like.

As the input device 24, a keyboard, a mouse, a microphone, or the like can be used. The monitor 25 (to be described later) also realizes a pointing device function in cooperation with the mouse. The input device 24 constitutes an input interface for specifying advertisement data to be presented by using selection information.

As the output device 25, in addition to a monitor (including a household television), a loudspeaker can be used (the output device 25 is described as a monitor 25 as needed). This output device 25 constitutes an output interface which simultaneously outputs the conversation data and the advertisement data output from the server apparatus 1 and an output interface which outputs selection information for selecting advertisement data to be presented from plurality of advertisement data.

Data are input to or output from the input device 24 and the output device 25 through the input/output control IF 26.

The communication control IF 27 is a communication unit which receives the advertisement data and the conversation data transmitted from the server apparatus 1 and the selection information and which transmits information related to advertisement data specified by the input device 24 to the server apparatus 1.

The client apparatus 2 constituted in this manner is connected to the internet 3 through a communication device such as a modem, a TA, or a router and a telephone line or a leased line, and can access the server apparatus 1 according to a predetermined communication protocol (for example, the TCP/IP internet protocol).

(Network)

As a network which connects the server apparatus 1 and the client apparatus 2 to each other, not only the internet 3 described above, but also an arbitrary network can be used. For example, this system can be structured by using a LAN, a WAN, or a personal computer communication network in a limited area. In addition, various data can also be transmitted and received by using a terrestrial wave, a CATV, a CS, a BS, or an ISDB (Integrated Services Digital Broadcasting). More specifically, the network can include not only a cable network, but also a wireless communication network.

(Processes in this System)

The details of processes performed by using this system constituted as described above will be described below. This processes are roughly classified into a Web page browsing process for browsing a Web page, a chat process for performing conversation in chat, and a message transmission process for transmitting a message.

It is assumed that in the member DB 10, the user IDs, the passwords, and the names of a plurality of user and the user IDs of friends are stored in advance by a known method. It is assumed that in the advertisement DB 13, selection information and advertisement data supplied from a sponsor or the like and an advertisement ID issued by an arbitrary method are stored in advance by communication depending on a FTP (File Transfer Protocol) or another known method.

(Web Page Browsing Process)

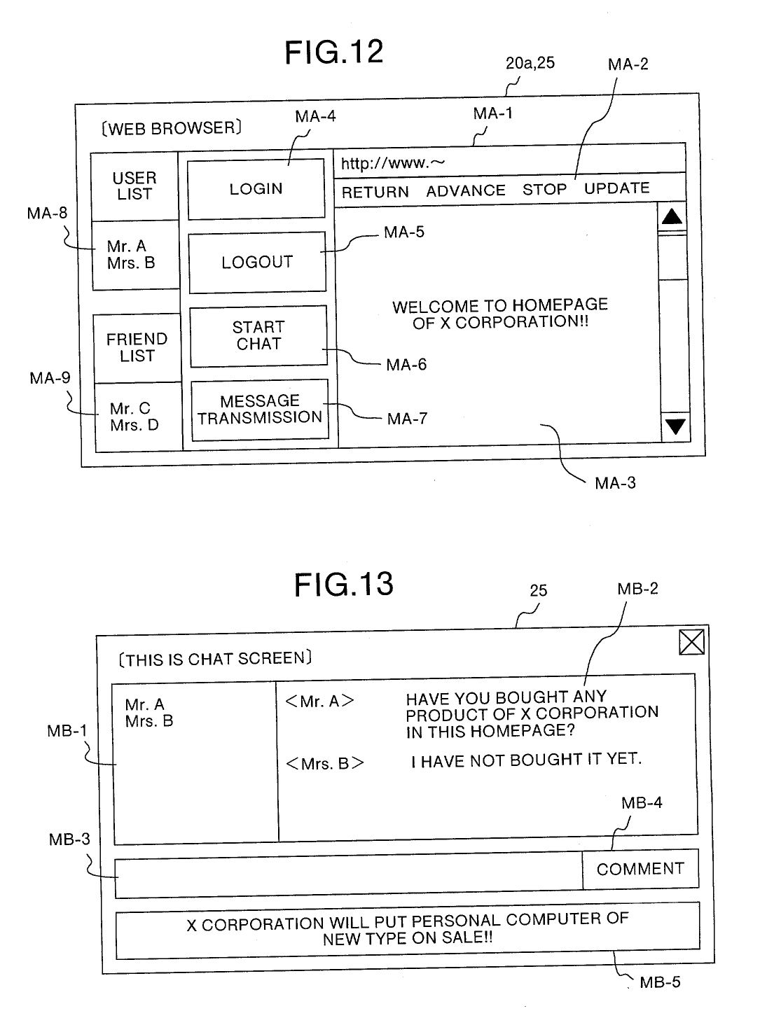

A Web page browsing process will be described below. A user starts the Web browser 20a in the client apparatus 2 by a predetermined method. A display of the Web browser 20a is shown in FIG. 12. As shown in FIG. 12, in the Web browser 20a, a URL input section MA-1, a menu section MA-2, a Web page display region MA-3, a login button MA-4, a logout button MA-5, a chat start button MA-6, a message transmission button MA-7, a user list MA-8, and a friend list MA-9 are displayed.

When a user selects the login button MA-4 through the input device 24, the Web browser 20a performs dial-up connection to the server apparatus 1. At this time, the user is requested to input a user ID and a password on a login screen (not shown). At this time the input user ID and the input password are transmitted to the server apparatus 1, and the authentication processing section 16c of the server apparatus 1 checks whether the user ID and the like coincide with a user ID and a password stored in the member DB 10 to authenticate the user. When the authentication is OK, the client apparatus 2 is connected to the internet 3. At this time, the authentication processing section 16c updates status information of the user (flag is set to be “1”)

Thereafter, the user inputs the URL of an arbitrary Web page in the URL input section MA-1 and requests transmission by a predetermined method. At this time, the Web browser 20a transmits the URL by a predetermined communication protocol through the communication control IF 27, and perform transmission request of Web data to the server apparatus 1 by routing based on the URL.

The request interpretation section 16a of the server apparatus 1 monitors the presence/absence of transmission from the client apparatus 2. When the request interpretation section 16a receives transmission, the request interpretation section 16a analyzes the contents of the transmission and shifts processes to the respective parts in the control section 16 depending on the analysis result. When the contents of the transmission is a transmission request of Web data, the browsing processing section 16b analyzes the address of the URL and returns an IP address obtained as the analysis result to the Web browser 20a.

The Web browser 20a accesses a Web server (not shown) in which Web data are stored by using the IP address, and acquires Web data from the Web server. The Web data is interpreted by the Web browser 20a. As a result, a Web page is displayed in the Web page display region MA-3 of the Web browser 20a (It is assumed that transmission request of Web data from the client apparatus 2 to the server apparatus 1, transmission of Web data to the client apparatus 2, and display of a Web page in the client apparatus 2 are almost similarly performed, and a description thereof will be omitted).

When the address solution is performed, the browsing processing section 16b stores the URL obtained by the address solution in the transmission history DB 11 such that the URL is associated with the user ID of a user who makes this request. When the user ID and a URL which is transmitted in advance have been stored, this URL is updated to a URL subjected to the latest address solution. In this manner, in the transmission history DB 11, the URL of the Web page recently transmitted to the client apparatus 2 of each user is stored.

The browsing processing section 16b refers to the transmission history DB 11 on the basis of the URL of the Web page transmitted to the user each time a browsing process of the Web page is performed, and calls the user ID of a user who watches the same Web page as that which is watched by the user. The browsing processing section 16b refers to the member DB 10 on the basis of the user ID, and calls the name of a user who watches the same Web page. The name called as described above is transmitted to the client apparatus 2 of a user and displayed in a user list. Therefore, each user watches the name of another user displayed in the user list, so that the user can recognizes the presence or the like of another user who browses the same Web page as that of the user. In the friend list, the name of another user acquired on the basis of the user ID of a friend stored in the member DB 10 is displayed.

Subsequently, in the same manner as described above, the user can browse an arbitrary Web page.

(Chat Process)

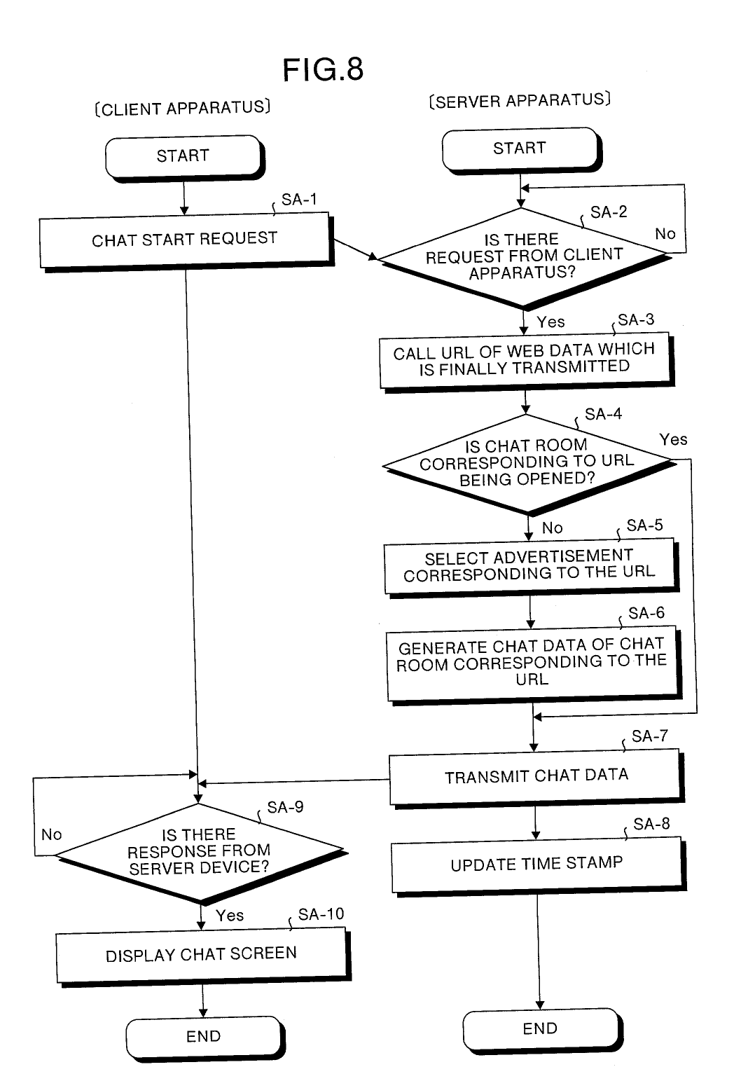

A chat process will be described below. The flow chart of the process is shown in FIG. 8. When a user selects a chat start button through the input device 24, a chat start request is transmitted to the server apparatus 1 (step SA-1) This request is given from the request interpretation section 16a to the chat processing section 16d, and the chat process is started by the chat processing section 16d. More specifically, the chat processing section 16d refers to the transmission history DB 11 to call the URL of a Web page finally transmitted to the user who perform this request (steps SA-2 and SA-3). The chat processing section 16d refers to the chat DB 12 on the basis of the URL to decide whether a chat room corresponding to the URL has been opened or not (in this case, whether the URL is stored in the chat DB 12 or not) (step SA-4).

(Chat Process-Automatic Selection of Advertisement Data)

When a chat room is opened, the chat processing section 16d calls chat data of the chat room from the chat DB 12 and transmits the chat data to the client apparatus 2 (step SA-7).

On the other hand, when no chat room is opened, the chat processing section 16d gives the URL to the advertisement selection processing section 16f. The advertisement selection processing section 16f automatically selects advertisement data added to the chat data on the basis of the URL (step SA-5).

As the logic of the automatic selection, various logics can be considered. However, matching between the contents of a Web page and advertisement data is performed to select advertisement data. More specifically, a Web page corresponding to the URL is acquired, a word included in the Web page is extracted. By using the word as a matching key, matching to advertisement data stored in the advertisement DB 13 is performed, and advertisement data having the highest matching rate is determined as advertisement data to be added to chat data. In addition, as the logic of the automatic selection, for example, a correspondence table representing the relationship between a URL and advertisement data is prepared in the server apparatus 1, and the advertisement data may be selected with reference to the correspondence table.

When the advertisement data is selected as described above, the advertisement data corresponding to a Web page which is browsed by a user or advertisement data having the common contents of users of the chat can be selected, and advertisement and public relations effects can be improved.

Unlike this embodiment, when a Web page which is browsed by a user and a chat room in which the user participates are not related to each other (when a user can open a chat room with an arbitrary theme, or when a user can select an arbitrary opened chat room and participates in the chat room), advertisement data may be selected depending on the contents of the chat room.

In this case, the chat processing section 16d of the server apparatus 1 selects arbitrary advertisement data at the start of chat. Conversation data (comment contents) written by a user after the chat is started are sequentially extracted or extracted at the timing of the process of advertisement selection or the like. By using the conversation data as a matching key, matching to the advertisement data stored in the advertisement DB 13. Advertisement data having the highest matching rate is determined as advertisement data to be added to the chat data.

In this case, even though the Web page and the chat room are not related to each other, advertisement data having the common contents of the users of the chat can be selected, and advertisement and public relations effects are improved.

Unlike this embodiment, users can have different advertisement data in the same chat room. In this case, the advertisement data can also be selected depending on the attributes of the users.

In this case, in the member DB 10 (a user attribute storage unit) of the server apparatus 1, arbitrary information for specifying the attributes of a user, e.g., the address, the age, the sex, the occupation, the native place, and the hobby of the user is stored. The attributes can be acquired when the user performs member registration in this system. The chat processing section 16d uses the attributes stored in the member DB 10 as matching keys to perform matching to the advertisement data stored in the advertisement DB 13, and determines advertisement data having the highest matching rate as advertisement data to be added to chat data.

In this case, advertisement data having contents depending on the attributes of a user of chat can be selected, and advertisement and public relations effects are improved.

In addition, as a matter of course, advertisement data can also be selected independently of a URL, the contents of conversation data of a chat room, and the attributes of a user. For example, advertisement data can be selected from the advertisement data stored in the advertisement DB 13 by a predetermined procedure (random selection, sequential selection, selection set in consideration of a predetermined priority order based on an advertisement fee or the like).

Advertisement selection can also be performed by not only a single logic, but also a combination of the plurality of logics for the advertisement selection. For example, when a plurality of advertisements correspond to the URL of a Web page which is browsed by a user, an advertisement depending on the attributes of the user may be selected from the advertisements.

(Chat Process-Generation, Display, or the Like of Chat Data)

The advertisement selection processing section 16f which selects advertisement data as described above gives the advertisement data to the chat processing section 16d. The chat processing section 16d generates chat data including the advertisement data (step SA-6), and transmits the chat data to the client apparatus 2 of a user which performs the chat start request (step SA-7). The chat data can be dynamically generated by using, e.g., a CGI (Common Gateway Interface) (generation of the following data can be performed by the same manner as described above).

The chat data generated as described above is added with a chat room ID by a predetermined method (for example, random generation, a serial number system, or the like). A URL, a user ID, chat data, and the advertisement ID of the selected advertisement data are stored in the chat DB 12 in association with each other.

After the chat data is transmitted to the client apparatus 2, the chat processing section 16d updates a time stamp corresponding to the chat data in the chat DB 12 by using time at which the chat data is transmitted (step SA-8). In this manner, the time stamp of the chat DB 12 represents participation time of a user who finally participates in each chat room.

On the other hand, in the client apparatus 2, a chat room is displayed on the monitor 25 (steps SA-9 and SA-10) This display is shown in FIG. 13. As shown in FIG. 13, in the chat room, a list MB-1 of users who participate in the chat room, a display region MB-2 for conversation data, an input section MB-3 in which conversation data is input, a transmission button MB-4 for designating transmission, and an advertisement display region MB-5 for displaying advertisement data selected by the advertisement selection processing section 16f are set. As shown in FIG. 12, a chat page in which a user participates while the user browses the Web page of “X Corporation” is illustrated. In the advertisement display region in FIG. 13, advertisement data of X corporation, i.e., “Personal computer of new type will be put on sale!!” is displayed.

Thereafter, as in a conventional chat system, chat is performed. More specifically, when a user input conversation data in the input section MB-3 through the input device 24 and selects the transmission button MB-4, the conversation data is transmitted to the server apparatus 1.

When the conversation data is transmitted from the client apparatus 2, the chat processing section 16d updates the chat data in the chat DB 12 by using the data.

Updating of a chat page displayed on each of the client apparatuses 2 is automatically performed such that the same page is reloaded at predetermined intervals by using the Refresh function of a META tag described inn an HTML constituting the chat page. In the followings, in the same manner as described above, conversation data is reflected to the chat page on almost real time, and a user can perform virtual conversation. In the followings, the same processes as described above are performed until all users participate in the chat room.

(Chat Process-Automatic Updating of Advertisement Data)

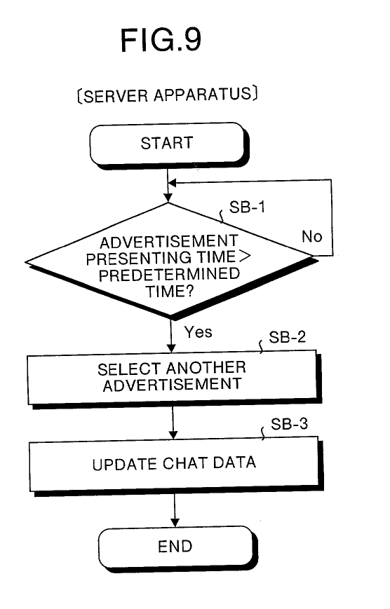

When predetermined conditions are satisfied while conversation is performed in the chat room, advertisement data is updated. The flow chart of the updating process is shown in FIG. 9. As shown in FIG. 9, the chat processing section 16d of the server apparatus 1 monitors an presenting time (display time) of an advertisement in each chat room to check whether the presenting time is equal to or longer than a predetermined time (for example, one minute) or not (step SB-1). More specifically, the chat processing section 16d refers to the time stamp of each chat room stored in the chat DB 12 at predetermined intervals to decide whether the time stamp represents time set a predetermined time or longer before the present time of the point of time or not.

When there is a chat room in which a presenting time of advertisement is equal to or longer than a predetermined time, the user causes the advertisement selection processing section 16f to select another advertisement data (step SB-2). The chat data is updated such that the advertisement data is displayed in the advertisement display region of the chat room (step SB-3).

The selection by the advertisement selection processing section 16f is performed such that advertisement data having the second highest matching rate is automatically selected in matching between a word included in a Web page corresponding to the URL and advertisement data stored in the advertisement DB 13. This finishes the updating process of advertisement data.

The chat data updated in this manner is loaded when a chat page is updated in each of the client apparatuses 2 as described above. As a result, new advertisement data is displayed in the advertisement display region of the chat room.

When the advertisement data is automatically updated, new advertisements can be sequentially presented to users, and advertisement and public relations effects can be further improved.

In particular, in the above description, since advertisement data is updated when each user who participates in the chat room continuously watches the same advertisement data for a predetermined time or longer, after each advertisement is sufficiently shown to the user, the next advertisement can be presented to the user. Therefore, advertisement updating can be efficiently performed.

(Message Transmission Process)

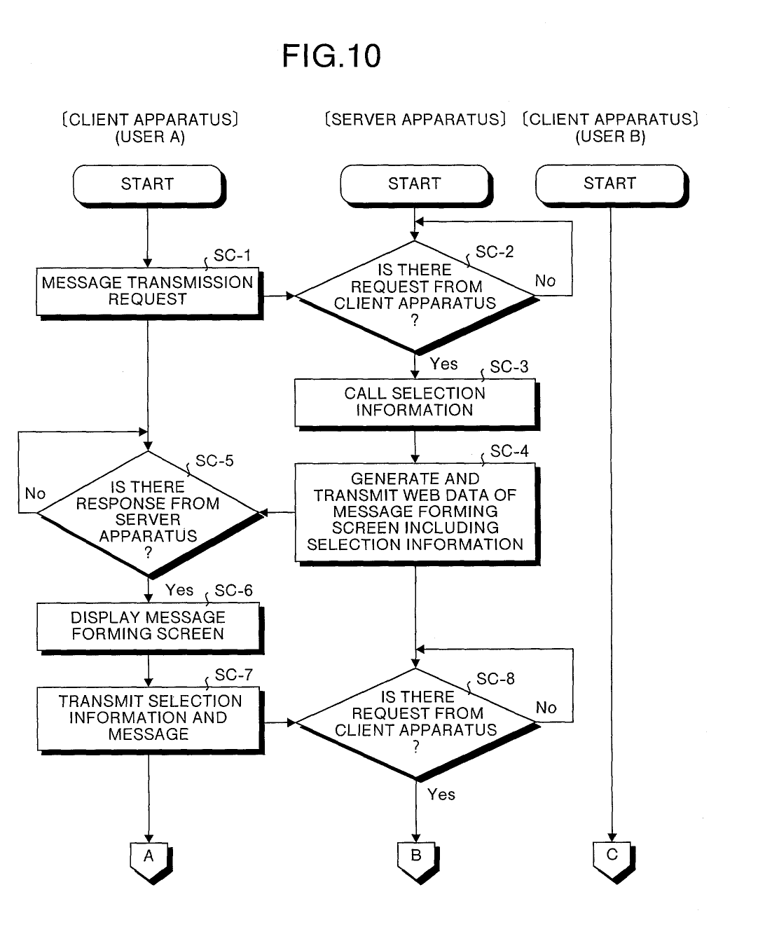

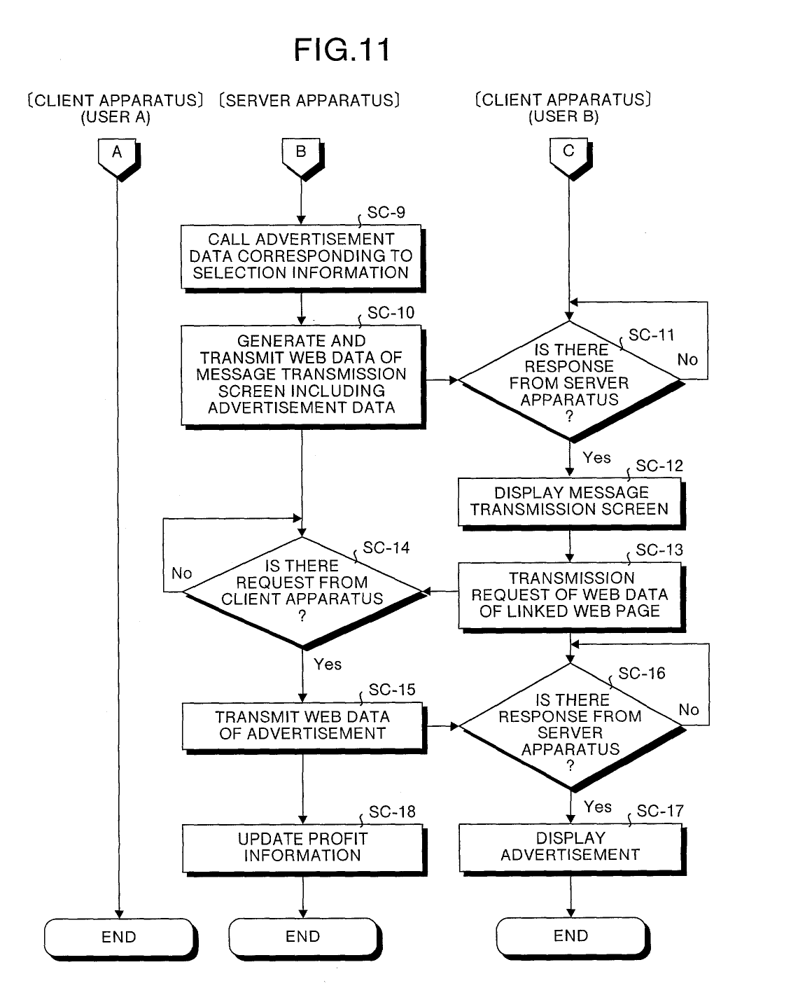

A message transmission process will be described below. The flow chart of the process is shown in FIGS. 10 and 11. In the Web browser 20a in FIG. 12, when User A specifies the opposite party for message transmission and select the message transmission button MA-7 through the input device 24, the Web browser 20a transmits a message transmission request to the server apparatus 1 (step SC-1). A method of specifying the opposite party for message transmission is arbitrarily determined. However, in this case, the opposite party can be specified by selecting another user displayed in the user list or the friend list by the input device 24.

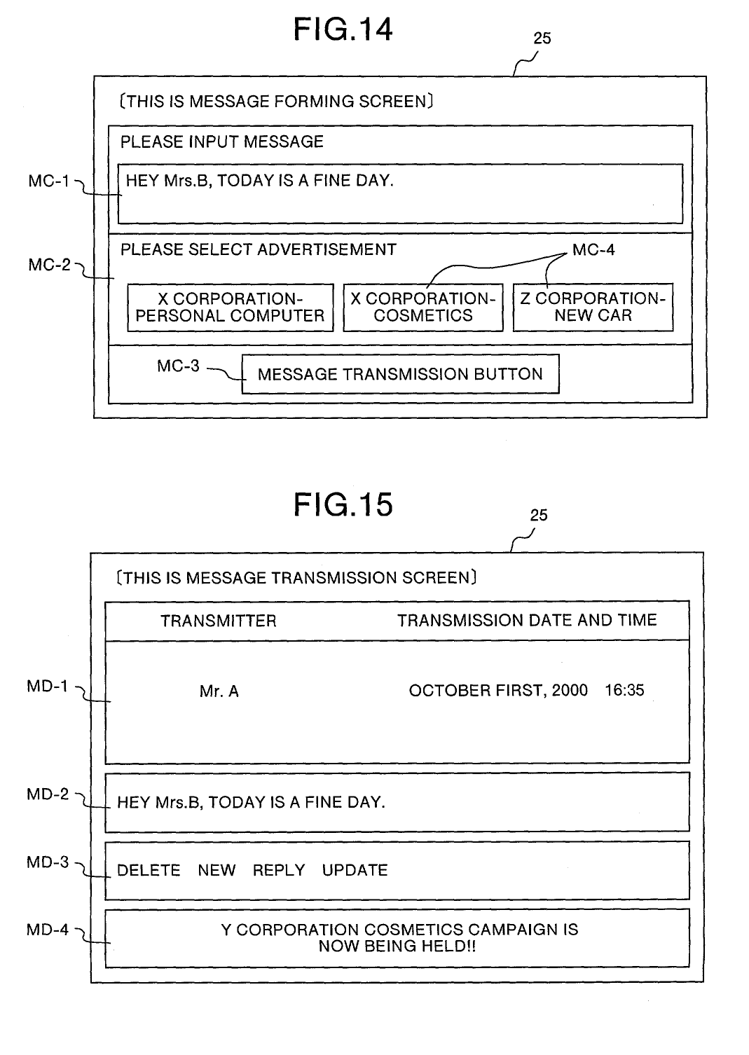

This message transmission request is given from the request interpretation section 16a to the message processing section 16e. The message processing section 16e calls selection information from the advertisement DB 13 (steps SC-2 and SC-3), generates the Web data of a message forming screen including the selection information, and transmits the Web data to the client apparatus 2 of the user who perform the request (step SC-4). The Web data is interpreted by the Web browser 20a of the client apparatus 2 and displayed on the monitor 25 (step SC-5 and SC-6) . A display of the message forming screen is shown in FIG. 14. This screen is constituted by, as shown in FIG. 14, an input section MC-1 in which conversation data (message contents) is input, an advertisement selection region MC-2 for selecting an advertisement, and a message transmission button MC-3 for designating transmission of a message.

In the advertisement selection region MC-2, selection information MC-4 called from the advertisement DB 13 is displayed as a list. User A selects, from the selection information, selection information corresponding to an advertisement to be transmitted to the opposite party for message transmission through the input device 24.

The selection information MC-4 can display thumbnails or various text information as described above. This display form can be arbitrary determined. A form such as a drop down-list form in which a user can easily perform selection can be used.

A selection timing of the selection information MC-4 is not limited to the timing of this embodiment. Information may be selected in advance before a message transmission request is performed. For example, the contents of an advertisement appropriate to each friend, the hobby of each friend, and the like are registered by a user in advance, and advertisement data may be selected on the basis of the contents.

Thereafter, User A inputs conversation contents in the input section MC-1 and clicks the selection information MC-4 to select advertisement data. When User A selects the message transmission button MC-3, the selection information and the conversation data are transmitted to the server apparatus 1 (step SC-7).

These pieces of information are given from the request interpretation section 16a to the message processing section 16e. The message processing section 16e calls advertisement data corresponding to the selection information transmitted from User A from the advertisement DB 13 (steps SC-8 and SC9), dynamically generates the Web data of a message transmission screen including the advertisement data and the conversation data transmitted from User A, and transmits the Web data to the client apparatus 2 of another User B which is selected by User A in advance (step SC-10). As a result, the message transmission screen including the advertisement data is displayed on the monitor 25 of the client apparatus 2 of User B (steps SC-l and SC-12).

A display of the message transmission screen is shown in FIG. 15. This screen is constituted by, as shown in FIG. 15, a display region MD-1 for displaying a transmitter of conversation data and transmission date and time of the conversation data, a message output section MD-2 for displaying the contents of conversation data, a menu section MD-3, and an advertisement display region MD-4. In the advertisement display region MD-4, advertisement data corresponding to selection information selected on the message input screen is displayed. In this case, it is assumed that “Y corporation-Cosmetics” is selected on the message forming screen in FIG. 14. In the message transmission screen in FIG. 15, an advertisement, e.g., “Cosmetics of Y Corporation, campaign is now being held!!” is displayed in the advertisement display region MD-4.

Thereafter, when User B wants to more exactly know the contents of the advertisement data, the advertisement display region MD-4 is selected by the input device 24. In the advertisement display region MD-4, a link to a homepage or the like showing the detailed contents of the advertisement data is pasted. When the advertisement display region MD-4 is selected, the Web browser 20a performs a transmission request of the Web data of the linked Web page (step SC-1).

This request is given from the request interpretation section 16a to the browsing processing section 16b, and address solution is performed by the browsing processing section 16b, so that the Web data is transmitted to the client apparatus 2 (steps SC-14 and SC-15). The linked Web page is displayed on the output device 25 (steps SC-16 and SC-17)

(Message Transmission Process-Profit Process)

In this manner, when the advertisement display region is selected by a user, and the fact that the advertisement display region is select is given from the browsing processing section 16b to the profit processing section 16g, and a profit process is performed by the profit processing section 16g. More specifically, the profit processing section 16g calls pieces of profit information of a user who performs message transmission and the user who selects the advertisement display region from the member DB 10, and adds predetermined points (for example, one point) to the pieces of profit information to update the pieces of profit information (step SC-18). This finishes the message transmission process.

(About Use of Acquired VM)

Thereafter, each user can use VM which is acquired by the corresponding user at an arbitrary timing. As a method of using virtual money on a network, various methods have been proposed and put to practical use yet. For this reason, the description of the concrete contents of the method will be omitted.

For example, a user designates that VM is used as a method of paying the price for a product in an electronic commerce site cooperated with this system, and the user inputs her/his user ID and her/his password. At this time, the system is inquired about settlement authentication on the basis of the information. The system authenticates the user by using the user ID and the password, and decides whether VM to be used by the user is stored in the member DB 10 or not. When the user is authenticated, and when the VM is stored in the member DB 10, the fact that the settlement is permitted is transmitted to the electronic commerce site, and VM corresponding to the price is subtracted from the VM stored in the member DB 10 to update the balance.

In addition, when the profit to be presented is cash, the cash is automatically transferred to a specified account. When the profit to be present is exchange tickets, the exchange tickets can be automatically can be mailed to the address of the user. As a matter of course, an operator may decide the contents of the member DB 10 to manually transfer cash or mail exchange tickets.

The embodiment of the present invention has been described above. However, the present invention may be performed in various different embodiments in the range of the spirit and scope of the invention.

For example, in the above embodiment, although the advertisement data is simply displayed on the monitor 25 as a still image, the advertisement data can also be output as a moving image or voice. In addition, all known output forms such as animation effects and flicker display can be used.

In the above description, a user selects advertisement contents in only message transmission. However, an opener or the like of a chat may select arbitrary advertisement contents when the chat is opened. This selection can be performed by the same procedure as that in the message transmission. In contrast to this, in message transmission, advertisement data can be automatically selected by the same procedure as that in the chat.

In the above embodiment, an example in which communication is performed by using the Web browser shown in FIG. 12 is described. However, even in chat or message transmission using widely popularized Web browsers (Internet Explorer and Netscape Navigator) or the like, advertisement display can be performed by the same procedure as described above.

In the above embodiment, a profit is uniformly given when an advertisement display region is selected. However, the contents and quantities of a profit to be given are changed depending on selection timings or the like of the contents of advertisement and advertisement display regions to achieve game properties.

In the embodiment, only one advertisement is displayed in chat or message transmission. However, a plurality of advertisements may be displayed.

Of the processes described in the embodiment, all or some of the processes which are described as automatically performed processes, or all or some of the processes which are described as manually performed processes can be automatically performed by a known method.

In addition, information including parameters such as the processing procedures, the control procedures, the concrete names, the various registration data, the searching conditions, and the like can be arbitrarily changed except that the information is specified.

A “computer readable storage medium” includes an arbitrary “portable physical medium” such as a floppy disk, a photomagnetic disk, a ROM, an EPROM, an EEPROM, a CD-ROM, or a DVD, an arbitrary “fixed physical medium” such as a ROM, a RAM, or an HD built in various computer systems, or a “communication medium”, which temporarily holds a program, such as a communication line or a carrier wave when a program is transmitted through a network typified by a LAN, a WAN, and the internet 3.

The “program” is a data process method described in an arbitrary language or by a description method, and the form of the “program” is not limited to a source code or a binary code. The “program” is not limited to a program which is singularly constituted. The “program” includes a program which is dispersively constituted as a plurality of modules or libraries or a program which is cooperated with another program typified by an OS (Operating System) to achieve the function of the program. As a concrete configuration and a reading procedure for reading a recording medium, an installing procedure after the reading, or the like in each of the apparatuses described in the embodiment, known configurations and known procedures can be used.

As has been described above, according to the first, third, fifteenth, or twenty-fifth aspect of the present invention, advertisement data is output to users together with conversation data, and advertisement for the users-can be performed in an information terminal apparatus. In this manner, a new advertisement space can be created in a conversation environment, i.e., a region which has not attracted attention as an advertisement space. In this case, since the advertisement data is displayed together with the conversation data which attracts a great deal of attention of the users, advertisement and public relations effects are extremely great.

According to the second, fourth, sixteenth, or twenty-fifth aspect of the present invention, in case of chat, an advertisement is watched by a user while waiting the next comment of the opposite party, or the advertisement is talked about in the chat, so that great advertisement and public relations effects can be expected. In case of message transmission, an advertisement can be actively transmitted together with a message, and great advertisement and public relations effects can be expected.

According to the fifth, seventeenth, or twenty-fifth aspect of the present invention, advertisement data to be presented to users is selected from the plurality of advertisement data, and is presented to the users. Therefore, when this selection is appropriately performed, an advertisement which is appropriate to the users can be automatically selected and presented to the users.

According to the sixth, eighteenth, or twenty-fifth aspect of the present invention, a transmission history of Web pages to users is automatically stored, and an advertisement is selected on the basis of the transmission history. For this reason, an advertisement which is browsed by the users and which is related to a manufacture, a product, and the like and an advertisement related to a manufacture, a product, and the like which are completely different from the manufacture, the product, and the like of the advertisement which is browsed by the users can be presented, i.e., an advertisement based on browsing contents can be presented, so that advertisement and public relations effects can be more improved.

According to the seventh, nineteenth, or twenty-fifth aspect of the present invention, since advertisement data is selected on the basis of the contents of conversation data, an advertisement about which users converse with each other and which are related to a manufacture, a product, and the like and an advertisement which is related to a manufacture, a product, and the like which are completely different from the manufacture, the product, and the like of the advertisement about which the users converse with each other can be presented, i.e., an advertisement based on the conversation contents can be presented, so that advertisement and public relations effects can be more improved.

According to the eighth, twentieth, or twenty-fifth aspect of the present invention, the information related to the attributes of the users, and an advertisement is selected on the basis of the information. For this reason, advertisement which is related to a manufacture, a product, or and the like which correspond to the sexes, the hobbies, and the like of the users and advertisement which is related to a manufacture, a product, and the like which are completely different from the manufacture, the product, and the like which correspond to the sexes, the hobbies, and the like of the users can be presented, i.e., an advertisement based on the attributes of the users can be presented, so that advertisement and public relations effects can be more improved.

According to the ninth, twenty-first, or twenty-fifth aspect of the present invention, since the advertisement data are automatically switched, different advertisements can be automatically presented to users, and advertisement efficiency can be improved.

According to the tenth, twenty-second, or twenty-fifth aspect of the present invention, since the advertisement data are switched when the present time of the advertisement data for the users who participate in the chat room is not shorter than the predetermined time, the next advertisement can be presented to the users while advertisements are sufficiently shown to the users, and the advertisements can be efficiently updated.

According to the eleventh, twenty-third, or twenty-fifth aspect of the present invention, a user can select advertisement data by using the selection information, and the advertisement data selected as described above is presented to the user. Therefore, in chat or message transmission, a user can perform arbitrary selection of an advertisement corresponding to the opposite party and the like, and advertisement and public relations effects can be more improved.

According to the twelfth, twenty-fourth, or twenty-fifth aspect of the present invention, when the predetermined operation is performed to the advertisement data, the contents of a profit offered to at least one of a user who performs this operation and a user who selects that the advertisement data is presented to the user are stored. More specifically, for example, when the advertisement data is selected to browse the detailed contents of the advertisement data, a predetermined profit is given to at least one of these users. Therefore, an incentive related to an improvement in advertisement effect can be given to users who watch the advertisement and users who transmit advertisement, and advertisement and public relations effects can be more improved.

According to the thirteenth aspect of the present invention, the conversation data and the advertisement data transmitted from the communication information processing apparatus can be simultaneously output through the output interface. Therefore, the advertisement data is output to users together with the conversation data, so that advertisement for the users can be performed. Since the conversation data especially attracts a great deal of attention, advertisement and public relations effects are extremely great.

According to the fourteenth aspect of the present invention, the selection information is output through the output interface, and the advertisement data is specified by using the selection information through the input interface. Therefore, a user can easily select advertisement data.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A communication system comprising:
a communication information processing apparatus for processing mutual conversation data of a plurality of users; and
an information terminal apparatus associated with each of the respective users, and which is connected to the communication information processing apparatus through a computerized network, wherein,
said communication information processing apparatus includes:
a conversation process arrangement for outputting both advertisement data which is representative of advertisement to the users and the conversation data; and
a first communication arrangement for transmitting the advertisement data and the conversation data to said information terminal apparatus, and wherein,
said information terminal apparatus includes:
a second communication arrangement for receiving the advertisement data and the conversation data transmitted from said communication information processing apparatus; and
an output arrangement for simultaneously outputting the conversation data and the advertisement data.

2. The communication system according to claim 1, wherein,
the conversation data is at least one of the following; chat information for displaying conversation contents, which is transmitted from the plurality of information terminal apparatuses, on the information terminal apparatuses, or
message information for displaying the conversation contents, which is transmitted from the information terminal apparatuses, on other information terminal apparatuses.

3. The communication system according to claim 1, wherein,
the communication information processing apparatus is a chat server or a message server, and the computerized network is the Internet.

4. A communication information processing apparatus for processing mutual conversation data of a plurality of users, and which is connected to an information terminal apparatus associated with each of users through a computerized network, comprising:
a conversation process arrangement for outputting both advertisement data which is representative of advertisement to the users and the conversation data; and
a communication arrangement for transmitting the advertisement data and the conversation data to said information terminal apparatus.

5. The communication information processing apparatus according to claim 4, wherein,
the conversation data is at least one of he following; chat information for displaying conversation contents, which is transmitted from the plurality of information terminal apparatuses, on the information terminal apparatuses, or message information for displaying the conversation contents, which is transmitted from the information terminal apparatuses, on other information terminal apparatuses.

6. The communication information processing apparatus according to claim 4, further comprising:
an advertisement selection process arrangement for selecting advertisement data from plurality of advertisement data.

7. The communication information processing apparatus according to claim 6, further comprising:
a transmission history data base for storing information for specifying a Web page transmitted to the information terminal apparatus, wherein,
the advertisement selection process arrangement selects the advertisement data on the basis of the information stored in the transmission history database.

8. The communication information processing apparatus according to claim 6, wherein,
the advertisement selection process arrangement selects the advertisement data on the basis of the contents of the conversation data.

9. The communication information processing apparatus according to claim 6, further comprising:
a user attribute data base for storing information related to attributes of said users, wherein,
the advertisement selection process arrangement selects the advertisement data on the basis of the information stored in the user attribute database.

10. The communication information processing apparatus according to claim 4, wherein,
the conversation process arrangement switches the advertisement data under predetermined conditions.

11. The communication information processing apparatus according to claim 10, wherein,
when the conversation data is chat information, and when a transmit time of the advertisement data for users who participate in the same chat room exceeds a predetermined time, the conversation process arrangement switches the advertisement data.

12. The communication information processing apparatus according to claim 4, wherein,
the conversation process arrangement transmits selection information, which is for selecting advertisement data from plurality of advertisement data, to said information terminal apparatus, and allow the advertisement data, which is selected by using the selection information, to be output to said information terminal apparatus.

13. The communication information processing apparatus according to claim 4, further comprising:
a profit information data base for storing profit information for specifying the contents of a profit offered to users; and
a profit process arrangement for, when a predetermined operation by the user is performed through said information terminal apparatus for advertisement data presented to the user, specifying the contents of a profit offered to at least either the user who performed the predetermined operation or other user who selects the advertisement data to be presented to the user, and storing the contents in the profit information data base.

14. The communication information processing apparatus according to claim 4, wherein,
the communication information processing apparatus is a chat server or a message server, and
the computerized network is the Internet.

15. An information terminal apparatus which is connected to a communication information processing apparatus for processing mutual conversation data of a plurality of users through a computerized network, comprising:
a communication arrangement for receiving the advertisement data and the conversation data transmitted from said communication information processing apparatus; and
an output arrangement for simultaneously outputting the conversation data and the advertisement data.

16. The information terminal apparatus according to claim 15, further comprising:
an input arrangement for being used to input a data, wherein,
the communication arrangement receives selection information, which is transmitted from said communication information processing apparatus, for selecting advertisement data from plurality of advertisement data,
the output arrangement outputs the selection information received by the communication arrangement,
the input arrangement is used to input the selection information, to specify the advertisement data based on the selection information, and
the communication arrangement transmits information related to the advertisement data, which is specified based on the selection information inputted by using the input interface, to said communication information processing apparatus.

17. A communication information processing method in a system including: a communication information processing apparatus for processing mutual conversation data of a plurality of users; and an information terminal apparatus associated with each of the respective users, which is connected to the communication information processing apparatus through a computerized network, comprising the steps of:
(a) outputting both advertisement data which is representative of advertisement for users and the conversation data, in said communication information processing apparatus; and
(b) transmitting the advertisement data and the conversation data from the communication information processing apparatus to the information terminal apparatus.

18. The communication information processing method according to claim 17, wherein,
the conversation data is at least one of fowlloing; chat information for displaying conversation contents, which is transmitted from the plurality of information terminal apparatuses, on the information terminal apparatuses, or
message information for displaying the conversation contents, which is transmitted from the information terminal apparatuses, on other information terminal apparatuses.

19. The communication information processing method according to claim 17, further comprising the steps of:
(c) selecting advertisement data from plurality of advertisement data, before the outputting step (a).

20. The communication information processing method according to claim 19, further comprising the steps of:
(d) storing information for specifying a Web page transmitted to the information terminal apparatus, in said communication information processing apparatus, and
wherein, on the selecting step (c), the advertisement data is selected on the basis of the information stored in the storing step (d).

21. The communication information processing method according to claim 19,
wherein, on the selecting step (c), the advertisement data is selected on the basis of the contents of the conversation data.

22. The communication information processing method according to claim 19, further comprising:
(e) storing information related to attributes of said users, and
wherein, on the selecting step (c), the advertisement data is selected on the basis of the information stored in the storing step (e).

23. The communication information processing method according to claim 17,
wherein, on the outputting step (a), the advertisement data is switched under predetermined conditions.

24. The communication information processing method according to claim 23,
wherein, on the outputting step (a), when the conversation data is chat information, and when a transmit time of the advertisement data for users who participate in the same chat room exceeds a predetermined time, the advertisement data is switched.

25. The communication information processing method according to claim 17,
wherein, on the outputting step (a), the selection information is transmitted for selecting advertisement data from plurality of advertisement data, from said communication information processing apparatus to said information terminal apparatus, and the advertisement data, which is selected by using the selection information, is allowed to be transmitted to said information terminal apparatus.

26. The communication information processing method according to claim 17, further comprising:
(f) storing profit information for specifying the contents of a profit offered to the users; and
(g) when a predetermined operation by the user is performed through said information terminal apparatus for advertisement data presented to the user, specifying the contents of a profit offered to at least either the user who performed the predetermined operation or other user who selects the advertisement data to be presented to the user, and storing the contents in said communication information processing apparatus.

27. The communication information processing method according to claim 17, wherein,
the communication information processing apparatus is a chat server or a message server, and
the computerized network is the Internet.

28. A computer-readable recording medium, wherein a computer program for a computer to execute a communication information processing method according to claim 17 is recorded.
